(19) United States
(12) Patent Application Publication
(10) Pub. No.: US 2011/0285506 A1
(43) Pub. Date: Nov. 24, 2011

(54) SYSTEM AND METHOD FOR TRACKING ITEMS

(76) Inventor: Joshua Bradley Hillis, St. George (CA)

(21) Appl. No.: 13/111,593

(22) Filed: May 19, 2011

Related U.S. Application Data
(60) Provisional application No. 61/346,274, filed on May 19, 2010.

(51) Int. Cl. H04Q 5/22; G08B 5/22

(52) U.S. Cl. 340/8.1; 340/10.1; 340/10.6

(57) ABSTRACT

The present invention is a system and method for tracking items. The present invention includes a device configured to perform registrations of items. The present invention may involve registering an item through use of a short-range communication system. The item may communicate via a short-range communication protocol and be associated with an identifier. A device may be utilized to scan for the item via the short-range communication protocol. Input to the device may be detected and recognized as indicating a snooze function that temporarily suppresses an alert associated with an out-of range condition for the item.

This application claims the benefit of U.S. Provisional Patent Application Ser. No. 61/346,274 filed May 19, 2010.

### FIELD OF INVENTION

The following relates to systems and methods for tracking items.

### BACKGROUND OF THE INVENTION

A person often carries, interacts with, or uses, various items while they go about their daily lives. In addition to carrying a wallet, keys, access cards, purses, and handbags, they may have various valuables that they keep on them, such as cell phones, smart phones, PDAs, digital music players, GPS devices, e-book readers, portable gaming devices, digital cameras, etc.

Many people keep records of inventories and other items in order to keep track of the quantity and location of such inventories/items. The preparation and maintenance of such records can be time-consuming. Keeping track of such a vast array of devices and items can also be difficult and prone to loss or misplacement. Given that people are more and more reliant on these devices and items, any loss or misplacement can be extremely disruptive and chaotic.

### SUMMARY OF THE INVENTION

In one aspect, the present disclosure relates to a method for tracking items using a device, the method comprising: enabling an item to be registered via a short-range communication system, the item being capable of communicating via a short-range communication protocol and having associated therewith an identifier (ID); enabling the device to scan for the item via the short-range communication protocol; and receiving data providing the location of the item to a user.

In another aspect, the present disclosure relates to a computer readable medium comprising computer executable instructions operable by a device to cause the mobile device to: enable an item to be registered via a short-range communication system, the item being capable of communicating via a short-range communication protocol and having associated therewith an identifier (ID); enable the device to scan for the item via the short-range communication protocol; and receive data providing the location of the item to a user.

In yet another aspect, the present disclosure relates to a method for tracking items using a device, comprising: tagging an item and registering the tagged item via a short-range communication system, the item being capable of communicating via a short-range communication protocol and having associated therewith an identifier (ID); initiating an App on a third party device; launching a core application enabling the device to scan for the item via the short-range communication protocol; and determining an action and a determine module.

In another aspect, there is provided a method for tracking items using a mobile or portable device, the method comprising: enabling an item to be registered via a short-range communication system, the item capable of communicating via a short-range communication protocol and having associated therewith an identifier (ID); enabling the mobile device to scan for the item via the short-range communication protocol; and upon detecting an input to the mobile device indicative of a snooze function, temporarily suppressing an alert associated with an out-of-range condition for the item.

In yet another aspect, there is provided a mobile or portable device configured for performing the method. In still another aspect, there is provided a computer readable medium comprising computer executable instructions that when executed by a mobile device cause the mobile device to perform the method.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a block diagram of an example system for tracking items.

FIG. 2 is a flow chart of an example object tracking application mapping.

FIG. 3 is an example mobile device displaying an example screen shot of a menu of applications comprising an object tracking application icon.

FIG. 4 is an example mobile device displaying an example screen shot of an object tracking main menu.

FIG. 5 is an example mobile device displaying an example screen shot of a setup menu.

FIG. 6 is an example mobile device displaying an example screen shot of a scanning progress screen during a tag addition process.

FIG. 7 is an example mobile device displaying an example screen shot of a tag scanning results screen for adding a new tag.

FIG. 8 is an example mobile device displaying an example screen shot of a settings menu.

FIG. 9 is an example mobile device displaying an example screen shot of a Go Find option for locating registered tags.

FIG. 10 is an example mobile device displaying an example screen shot of an alerts menu.

FIG. 11 is an example mobile device displaying an example screen shot of an alert snooze menu.

FIG. 12 is an example mobile device displaying an example screen shot of an out-of-range alert.

FIG. 13 is an example mobile device displaying an example screen shot of a set of tag scanning results.

FIG. 14 is an example mobile device displaying an example screen shot of a directional function for a selected tag.

FIG. 15 is an example mobile device displaying an example screen shot of a tag list control option.

FIG. 16 is an example mobile device displaying an example screen shot of another application running with a tracking status bar.

FIG. 17 is a flow chart illustrating an example set of computer executable instructions for scanning a tag.

FIG. 18 is a flow chart illustrating an example set of computer executable instructions for performing an scheduled scan.

FIG. 19 is a flow chart illustrating an example set of computer executable instructions for providing a snooze option.

FIG. 20 is a flow chart represented upon the layers of an embodiment of the present invention wherein the present invention is a core application.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is a system and method for tracking items. The present invention includes a device configured to perform registrations of items. The present invention may involve registering an item through use of a short-range communication system. The item may communicate via a short-range communication protocol and be associated with an identifier. A device may be utilized to scan for the item via the short-range communication protocol. Input to the device may be detected and recognized as indicating a snooze function that temporarily suppresses an alert associated with an out-of range condition for the item.

References herein to devices, for example, such as mobile or portable devices, that may be mobile or portable communication devices, may include many types of devices such as any of the following: cell phones, smart phones, PDAs, digital music players, GPS devices, e-book readers, portable gaming devices, digital cameras, tablets, netbooks, laptops, and any other devices that may be mobile or portable.

In order to keep track of the various other items that the user may carry, a device may be configured to provide a convenient platform to keep track of such items and their proximity to the device. Since the device is likely near the user, the other items, if within a certain distance of the device, should also be near the user. To address that the number of items carried by the user which they desire to track can vary over time and thus tracking these objects should be convenient and the ability to add, remove and manage the changing nature of what should be tracked and not tracked at any given time is paramount. The ability to temporarily suppress an alert associated with an out-of-range condition may also be provided.

Often a single device, for example, such as mobile or portable communication device, is carried by a user to act as a means of communicating (e.g. via text messaging, email, phone, instant messaging, inventory keeping, location registering, etc.) and of organizing their daily routines and lives generally. It has been realized that such a device is typically the one item that is carried by a user most if not all the time. In order to keep track of the various other items that the user may carry or monitor, the device provides a convenient platform to keep track of such items and their proximity to the device. Since the device is likely near the user, the other items, if within a certain distance of the mobile device, should also be near the user, or at least in specific locations that the user should be able to detect. This detection by the user may facilitate a form of inventory keeping by the user.

It has also been realized that the number of items carried and monitored by the user which the user desires to track can vary over time and thus tracking these objects should be convenient and the ability to add, remove and manage the changing nature of what should be tracked and not tracked at any given time is paramount. In order to achieve these objectives, an object tracking application will now be described that provides a flexible platform to manage the tracking of items while accommodating variations in what should and should not be tracked at any given time.

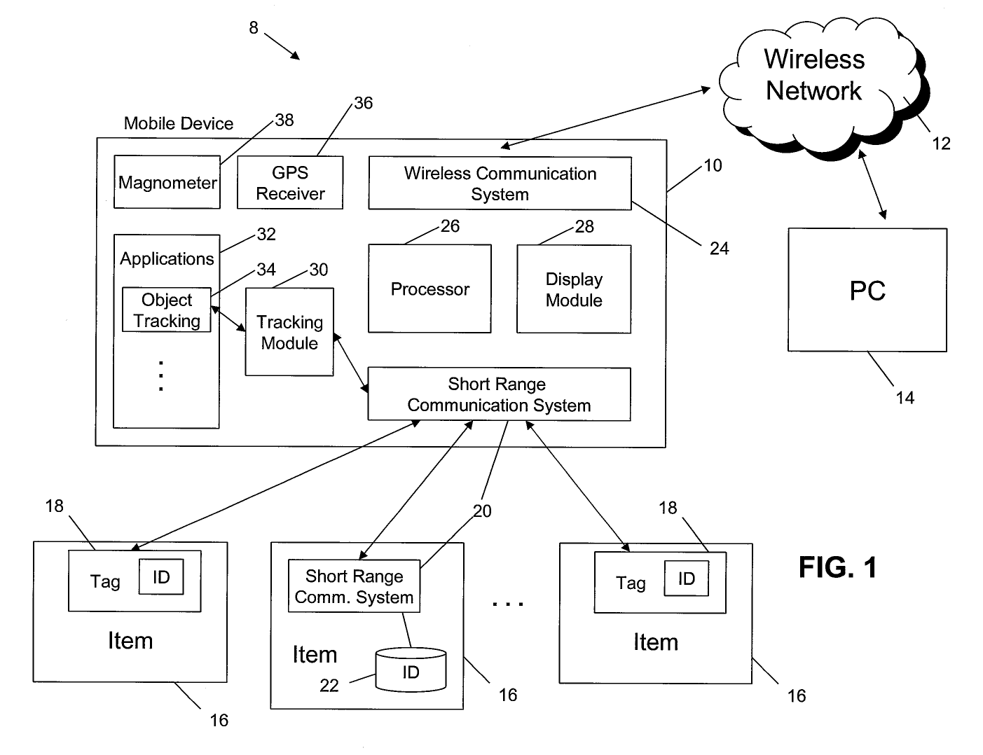

Turning now to FIG. 1, a system 8 is shown for tracking items 16 via a device 10. The device 10 may be any device that is capable of communicating with the items 16 via a short-range communication system 20. As shown by way of example in FIG. 1, each item 16 has associated with it, an identifier (ID) that enables the mobile device 10 to distinguish between items 16. The item 16 may have a communicative tag 18 attached thereto, or may itself have a short-range communication system 20 and a memory 22 storing the ID in the item 16. As such, the system 8 enables the mobile device 10 to track both passive items 16 such as keys, a wallet, inventory items, or work items, or active devices such as other electronic devices. As illustrated, the mobile device 10 may be configured to track any number of items 16 and three are shown in FIG. 1 for illustrative purposes only.

In another embodiment of the present invention the system may include software or other computer program products operable to trigger particular activities and/or actions. Such activities and/or actions may be of a variety of types, as described herein. The activities and/or actions may involve or otherwise incorporate third party software or computer program products for which the present invention is granted permission to activate or otherwise access.

The device 10 may also be, and is most typically, a device that provides wireless connectivity via a wireless communication system 24. The wireless communication system 24 enables the device 10 to communicate via a wireless network 12, e.g. with a personal computer (PC) 14 or other device that is also connectable to the wireless network 12. As will be described below, the wireless communication system 24 can be used to provide back-up data or other object-tracking data to the user's PC 14 or to enable the PC 14 to remotely monitor the items 16 which are in turn tracked by the mobile device 10. In this way, the mobile device 10 can also itself be tracked, e.g. by providing its location to the PC 14 or to report its most recent GPS position to record where the mobile device 10 was when a particular item 16 was unable to be located.

The mobile device 10 in this example comprises a processor 26 and a display module 28 enabling the mobile device 10 to perform various operations and display data to the user as is well known in the art. The mobile device 10 also comprises a magnometer 38 to provide a heading measurement, and a GPS receiver 36 for determining a current location for the device 10. The device 10 includes memory that enables various applications 32 to be used. In this example, those applications 32 include an object tracking application 34 for tracking the proximity of the items 16 to the device 10. The object tracking application 34 may utilize an object tracking module 30 that operates on the device 10 in order to initiate communications with the items 16 and to provide data to the object tracking application 34 in order to enable it to provide a user interface (UI) to the user via the display module 28.

The short-range communication system 20 may comprise any suitable protocol such as Bluetooth, radio frequency identification (RFID), infrared (IR), optical, or other near-field communication protocols. The short range communication system may include one or more suitable protocols. The one or more protocols utilized by the system may be the one or more protocols that are most convenient for the specific tracking purpose to which the system is to be applied. Should more than one protocols be included in the system such multiple protocols may be utilized simultaneously. The protocol used may be capable of communicating with or at least obtaining some information from the tag 18 or the short-range communication system 20 of the item 16. As such, a suitable pairing protocol that is well known in the art can be used in order to determine which item 16 includes what tag 18, based on the ID. In some embodiments, e.g. where Bluetooth is used, distance measurement can be made, e.g. by measuring response times from an item 16 being paired. A skilled reader will recognize that other methods of determining distance may also be used in the present invention.

It will be appreciated that any module or component exemplified herein that executes instructions may include or otherwise have access to computer readable media such as storage media, computer storage media, or data storage devices (removable and/or non-removable) such as, for example, magnetic disks, optical disks, tape, and other forms of computer readable media. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD), blue-ray disks, or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 10, tracking module 30, object tracking application 34, etc., or accessible or connectable thereto. Any application or module herein described may be implemented using computer readable/executable instructions that may be stored or otherwise held by such computer readable media.

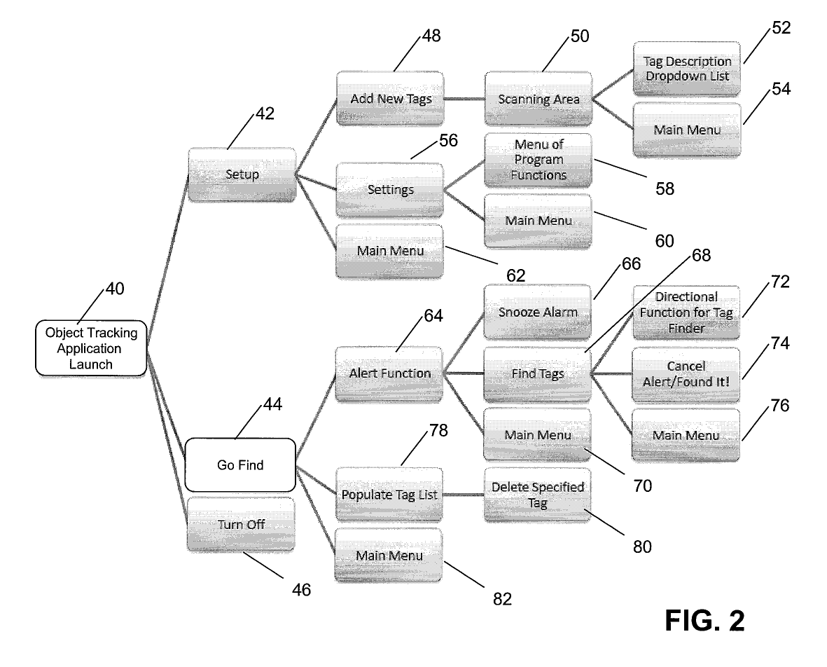

The object tracking application 34 provides a UI to enable the user to more conveniently manage the items 16 which are to be tracked. It has been realized that situations arise where items 16 may temporarily go out-of-range of the mobile device 10 and thus the ability to temporarily suppress alerts for those items 16 avoids false alarms. Since false alarms can lead to user complacency, avoiding false alarms is important to the usability of the application 34. FIG. 2 illustrates an example application mapping for the object tracking application 34.

Upon launching the object tracking application 34 at 40, the UI enables a setup branch at 42, a usage branch denote “Go Find” at 44, and the ability to turn off the tracking application 34 at 46. Within the setup branch 42, new tags can be added at 48, which triggers an area scan at 50 and the ability to describe found tags at 52 to distinguish between those that are within the area. The mapping may also enable the user to return to the main menu at 54. The setup branch 42 also provides a setting sub-branch at 56. The settings branch 56 provides a menu of program functions 58 to enable the user to customize the manner in which the items 16 are tracked (e.g. if manual scanning or automatic scanning is preferred, etc.), and the ability to return to the main menu at 60. The setup branch 42 also itself enables the user to return to the main menu at 62.

In one embodiment of the present invention the system may be operable to detect new tags automatically and to incorporate and/or store these tags in a database. This activity of automatically detecting new tags and storing these may offer advantages to a user relating to inventory.

The Go Find branch 44 enables the user to initiate an alert by entering an alert function branch at 64. The alert function branch 64 provides the user with the ability to initiate an alert snooze function at 66 in order to temporarily suppress an alert when appropriate. The alert function 64 also enables the user to perform an area scan to find tags that have been registered at 68 or return to the main menu at 70. If selecting the find tags branch at 68, the user can perform advanced features such as a directional function at 72, cancel the alert at 74, or return to the main menu at 76. The Go Find branch 44 also enables the user to populate a tag list at 78. This can be used to add or remove registered tags to customize which items 16 should be tracked at any given time. Also, the user can delete a specified tag at 80. The Go Find option 44 also enable the user to return to the main menu at 82.

It can be appreciated that the application mapping shown in FIG. 2 is illustrative only and various other application flow branching can be used. For example, the ability to populate the tag list can be performed in the settings option 56 or directly from the main menu. It may be noted that by providing various tiers of simple branching as shown in FIG. 2, the user is able to quickly navigate both laterally and in depth through the various option providing a convenient way to manage which items 16 are to be tracked, when and how they are tracked, etc.

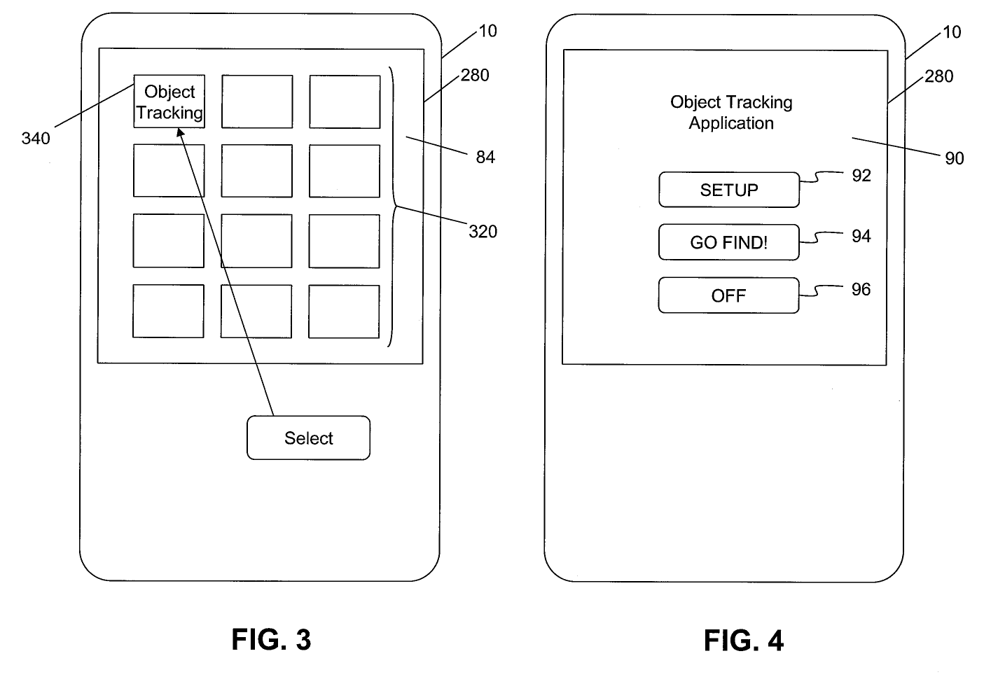

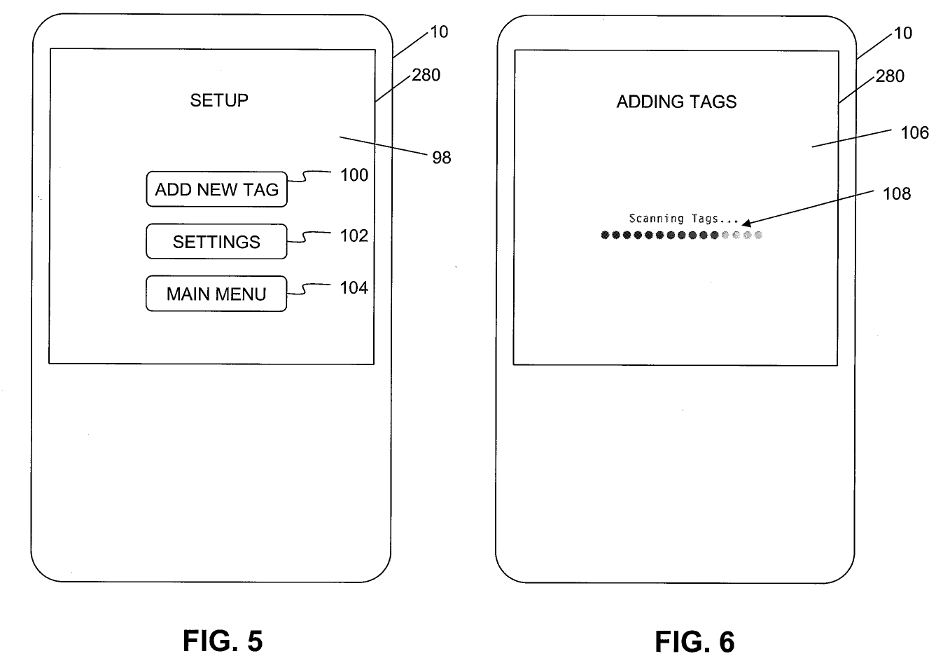

FIGS. 3 through 16 illustrate example UI screen shots for providing the features shown in the application mapping of FIG. 2. In FIG. 3, a mobile device display 280 is shown which displays a home screen 84 comprising a series of icons 320 as is well known in the art. In this example, the series of icons 320 includes an object tracking icon 340. By selecting the object tracking icon 340, an object tracking main menu 90 is displayed as shown in FIG. 4. In this example, the main menu 90 comprises a setup option 92, a Go Find option 94, and an OFF option 96. By selecting the setup option 92, a setup menu 98 is displayed as shown in FIG. 5. The setup menu 98 comprises an Add New Tag option 100, a settings option 102, and a main menu option 104. By selecting the Add New Tag option 100 a tag scanning screen 106 is displayed as shown in FIG. 6. The scanning screen 106 comprises a progress bar 108 to indicate to the user that the scanning is in progress.

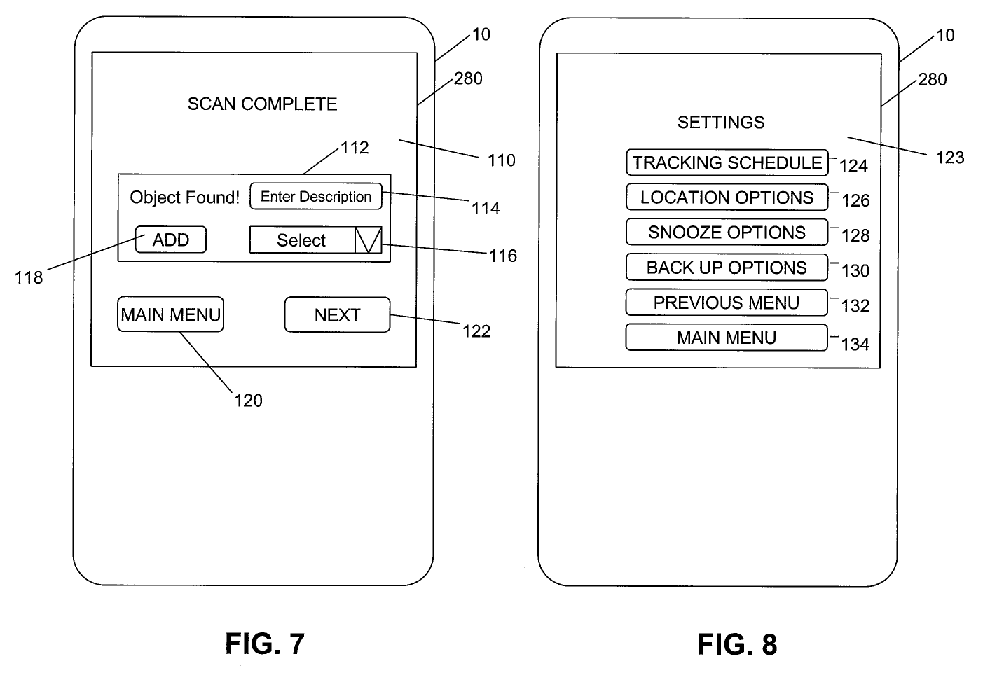

Once the scanning is completed, a scan complete screen 110 is displayed as shown in FIG. 7. The scan complete screen 110 provides an object identification option 112 to enable the user to distinguish items 16 from each other. In this example, the identification option 112 provides an enter description option 114 to enable a custom description to be added. The user may also use a pull-down list 116 to associate one of a number of pre-stored descriptions. For example, common items such as keys, wallet, purse, camera, etc. can be pre-populated to enable the user to quickly match the description to the item 16 that is scanned. Inventory items, or any other item, or items, that may require tracking, may also be pre-populated to enable the user to quickly match the description to the item that is scanned. In this example, the scan complete screen 110 enables the user to add items 16 one at a time and thus if multiple tags 18 are found in the scanning area (e.g. within Bluetooth pairing range), an add option 118 can be selected then a next option 122 to display the identification option 112 for the next item 16 to be registered. A main menu option 120 is also displayed to enable the user to navigate quickly back to the main menu 90 once the registration is complete (e.g. to then move into the Go Find branch 44.

As noted above, the setup menu 98 also comprises a settings option 102. By selecting the settings option 102, a settings menu 123 is displayed as shown in FIG. 8. In this example, various illustrative settings options are shown but it will be appreciated that various others may also be provided. In this example, a tracking schedule option 124 enables the user to configure the object tracking module 30 to perform automatic scanning in order to determine if items 16 are out-of-range without the user having to initiate a scan. A location options button 126 is also provided which enables the user to configure various location-based options. For example, the user may be given the ability to send location information periodically to the PC 14 in order to record where the mobile device 10 was at various times. This enables a location to be correlated to a time at which a particular item 16 went out-of-range to facilitate retrieval or recovery of a lost or misplaced item 16.

A snooze options button 128 is also shown in FIG. 8. The snooze options button 128 can enable the user to customize the way in which a snooze feature is used. It has been found that there are situations in which an item that is actively being tracked is going to be temporarily out of range and thus the tracking can be “snoozed” for a period of time. The period of time during which a snooze occurs may be a determined or an undetermined period of time. For example, if a user is at an event wherein their purse or handbag or wallet in a jacket pocket or keys is/are to be placed in a room or coat-check, they may wish to snooze alerts for those items should an alert be displayed. As another example, if an inventory item is temporarily removed from its location for any purpose a user may wish to snooze alerts for the inventory item that is temporarily removed should an alert be displayed. This enables the user to temporarily ignore alerts for particular items without having to go through the trouble of removing the item 16 from the object tracking application's list of items 16 to be tracked and then later add it again.

A back up options button 130 is also shown which, when selected can provide a user with options related to backing-up the data stored by the object tracking application 34. For example, the object tracking application 34 can store ID and other registration related data that if backed up by sending such data to the PC 14, and can be used to update a new device to allow seamless tracking when upgrading or using different devices. Also, if the device 10 becomes misplaced, the PC 14 would have some data with which to track down the items 16 that the device 10 is tracking and/or the device 10 itself. Also shown in FIG. 8 are a previous menu option 132 and a main menu option 134 to enable navigation back to the setup menu 98 or the main menu 90 respectively.

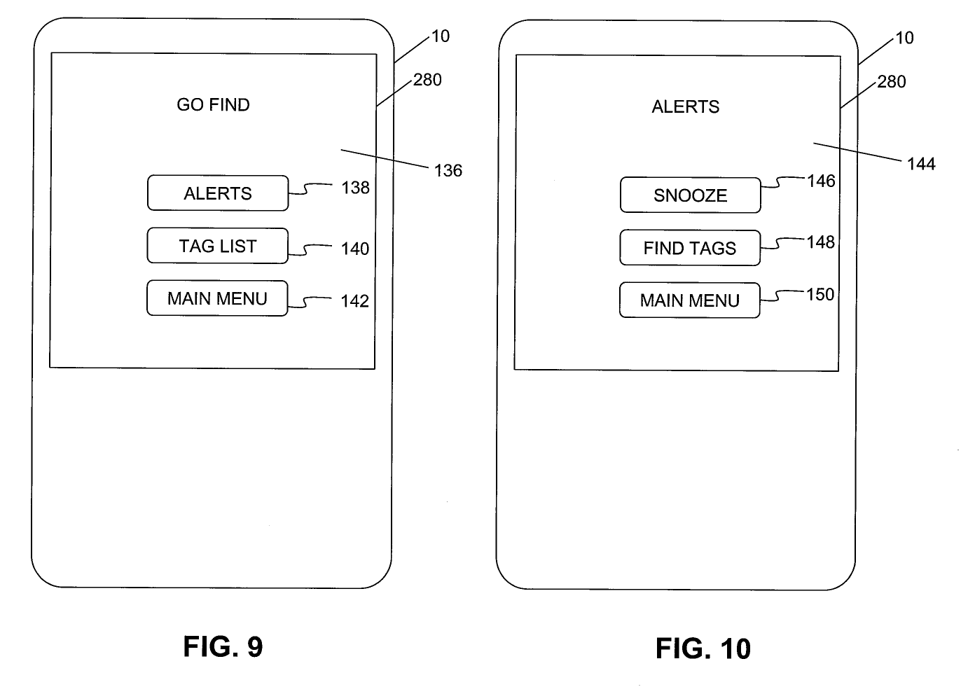

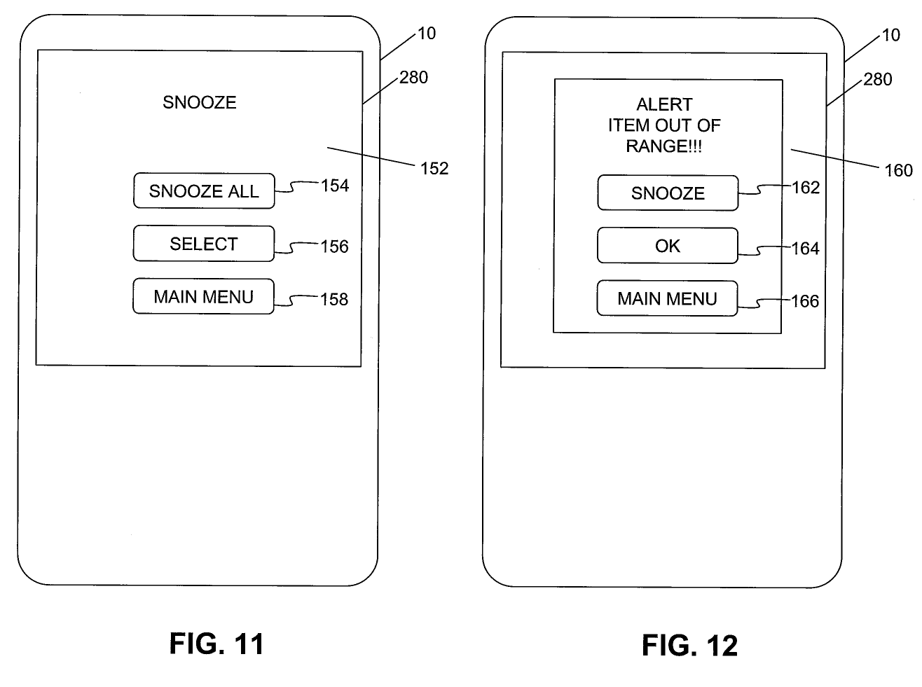

Turning now to FIG. 9, a Go Find menu 136 is shown which is displayed upon selecting the Go Find option 94 in the main menu 90. The Go Find menu 136 in this example comprises an alerts option 138, a tag list option 140, and a main menu option 142. By selecting the alerts option 138, an alerts menu 144 is displayed as shown in FIG. 10. The alerts menu 144 provides options associated with using the object tracking application 34, e.g. to initiate a tag scan or to proactively initiate a snooze option for one or more tags 18. By selecting the snooze option 146, a snooze menu 152 is displayed as shown in FIG. 11. The snooze menu 152 comprises a Snooze All option 154 to enable the user to apply a snooze function to all tags 18 (e.g. if they temporarily want to ignore all alerts), a select option 156 to enable the user to select which tags 18 to apply the snooze function to, and a main menu option 158.

It can be appreciated that the snooze menu 152 enables the user to proactively apply snooze functions in order to pre-emptively suppress various alerts. However, as shown in FIG. 12, automatic alerts 160 (or alerts associated with a manual scan) may be displayed at various times, e.g. when it is detected that a particular item 16 is out-of-range of the short-range communication system 20. In such cases, the alert 160 may provide a snooze option 162 to enable the user to snooze the alert on-the-fly, e.g. in case they realize that the alert relates to something that does not need to be tracked at that time. The alert 160 may also provide an OK option 164 which, when selected, enables the user to acknowledge the warning and take appropriate action (e.g. look for the item 16). A main menu option 166 is also provided to enable the user to quickly navigate to the setup menu 98 or other features in order to change settings, remove the item 16 from the scanning list, etc.

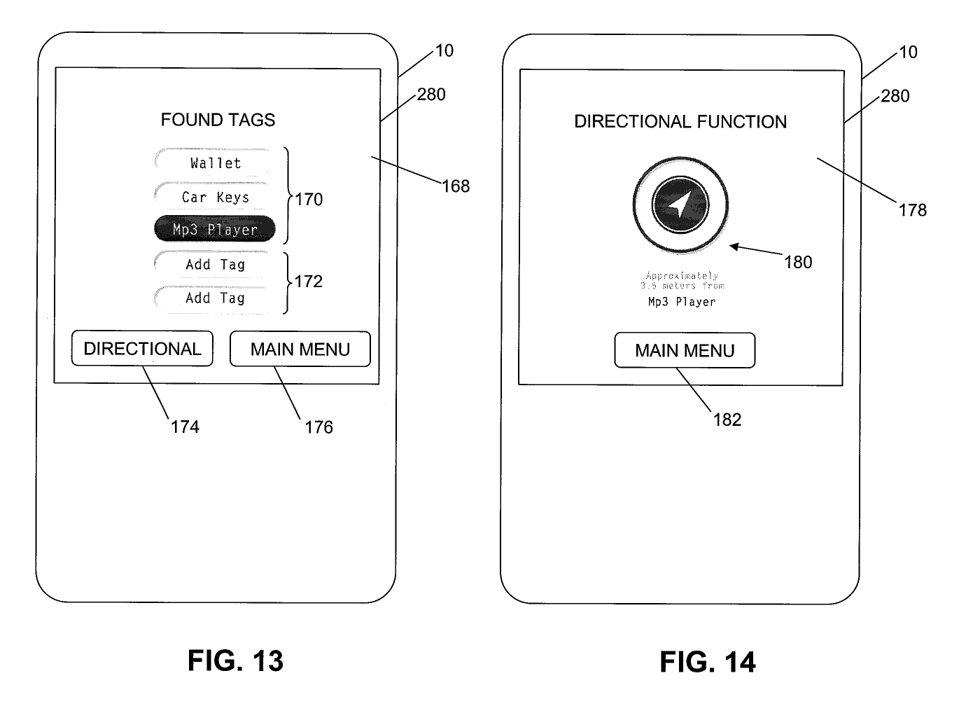

By selecting the find tags option 148 from the alerts menu 144, a found tags screen 168 is displayed as shown in FIG. 13. It can be appreciated that a scanning progress 108 such as that shown in FIG. 6 may be used while the tags 18 are being found. The found tags screen 168 in this example provides a list of found tags 170 and an Add Tag option 172 to give the user the ability to immediately add another tag 18 to the registered list. By selecting one of the tag entries 170 as shown in FIG. 13, a directional option 174 may then be selected to enable the user to track the relative location of the selected entry 170 as shown in FIG. 14. In this example, the Mp3 player is subjected to a directional function and a directional function screen is displayed 178. The directional function determines the proximity of the selected item 16 with respect to the mobile device 10 (e.g. using a ping or other process) and reports this to the user via a graphic 180. A main menu option 182 is also provided to enable the user to quickly navigate back to other options.

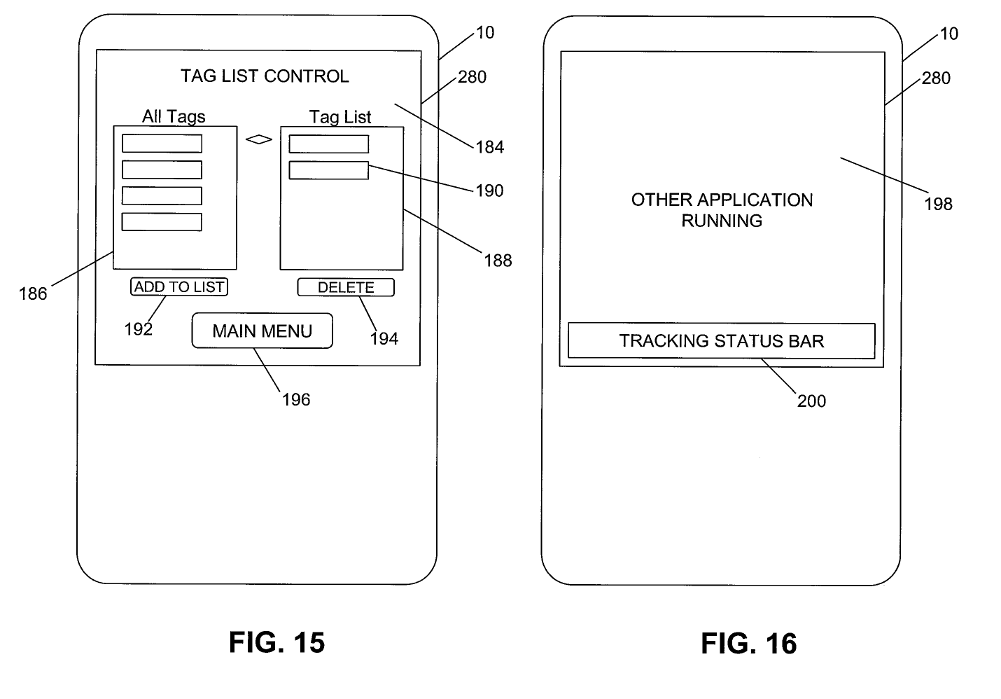

As noted above, the Go Find menu 136 comprises tag list option 140. By selecting the tag list option 140, a tag list control screen 184 is displayed as shown in FIG. 15. In this example, the tag list control screen 184 enables the user to conveniently add or remove tags 18 from a scanning list so that only alerts for items 16 in the scanning list are provided to the user. In this way, the user can be required to only register items 16 once but then be able to add or remove them from active tracking in a dynamic way. A master list 186 of all tags 18 is shown and the user can add lists tag entries 190 to a tag scanning list 188 by selecting an Add to List option 192. Conversely, to remove a tag entry 190 from the scanning list 188, the entry can be selected and a Delete option 194 used. A main menu option 196 is again provided to enable easy navigation back to the main menu 90.

In the above-described examples, the scanning and alerts can be initiated by the user or an automatic tracking routine can be implemented to periodically scan the tags on the scanning list 188 in order to determine when items 16 become out-of-range. In addition to the object tracking application interfaces shown in FIGS. 4 through 15, a tracking status bar 200 or other condensed tracking interface component can be displayed while other applications 198 are running as shown in FIG. 16. This enables the user to keep track of items and alerts can be provided in the status bar 200 instead of taking over the display. It can therefore be appreciated that various UI components can be used in order to provide the user with the ability to determine whether or not an item being tracked is in or out of range and/or be able to snooze alerts and navigate into various menu options.

In one embodiment of the present invention out of range retrieval may be enabled on a device. For example, based on a time interval, the position of the device may be captured relative to one or more tracked items. The relative position may be correlated to the results of past scans. The result of the correlation may be one or more suggestions of possible locations for the device for out of range items. The result of the correlation may also offer a possible direction that a user may move a device in order to come within range of an item and thereby to reinitiate a scan to find the item that was previously out of range.

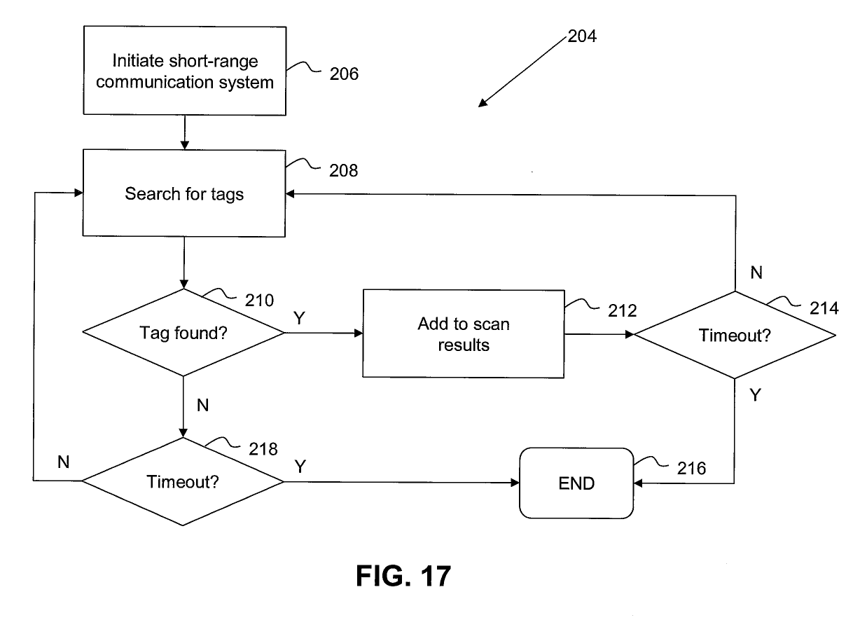

Turning now to FIG. 17 an example set of computer executable instructions 204 are shown that may be implemented by the object tracking application 34 and/or object tracking module 30 for scanning tags 18 within range of the mobile device 10. At 206, the short-range communication system 20 is initiated and the object tracking module 30 uses the short-range communication system 20 to search for tags at 208, e.g. using a Bluetooth pairing procedure. The object tracking module 30 then determines at 210 whether or not a tag 18 has been found. If yes, the found item is added to the scan results at 212 and may be compared to registered tags 18 to filter out other devices within range that are not being tracked (e.g. other users' devices). The object tracking module 30 in this example enables scanning to occur for a predetermined amount of time (i.e. timeout period) in order to enable as many tags 18 as possible to be found. At 214 the object tracking module 30 determines if the timeout has been exceeded. If not, the object tracking module 30 continues scanning. If so, the process ends at 216. If a tag 18 is not immediately found, the object tracking module 30 may reference the timeout at 218 and if it has not been exceeded may continue to search at 208.

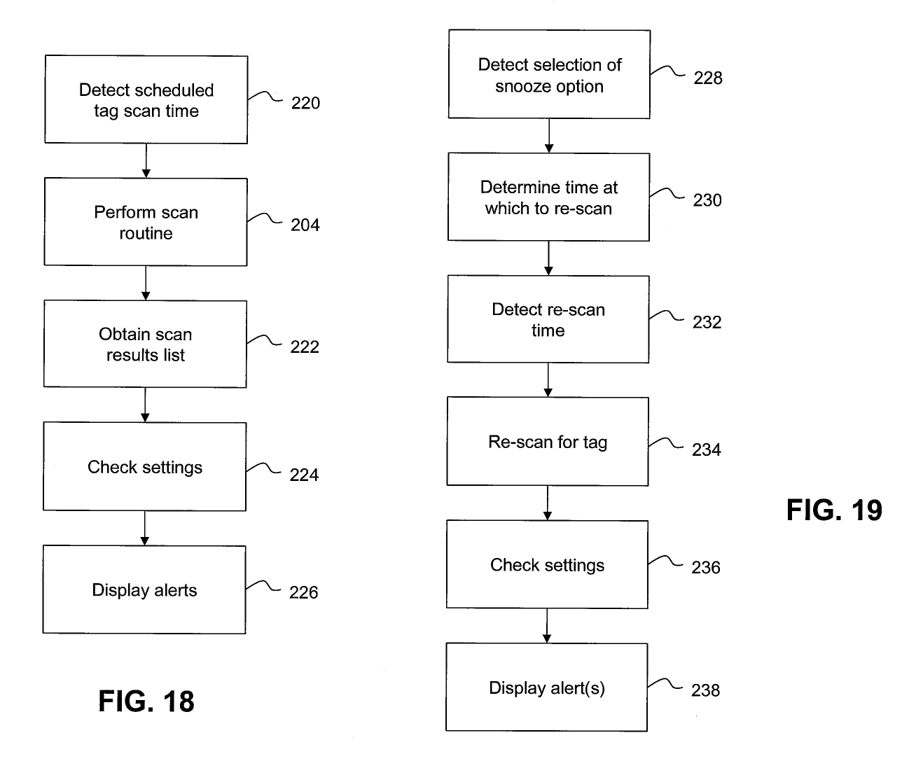

FIG. 18 illustrates an example set of computer executable instructions that may be implemented by the object tracking application 34 and object tracking module 30 to perform an automatic scan and alert process. At 220, the object tracking module 30 detects a scheduled scan time, e.g. hourly. The scan routine 204 shown in FIG. 17 may then be used to determine which tags 18 can be found. From the scan routine 204 a scan results list is obtained by the object tracking module 30 at 222. The object tracking module 30 may then compare the results list to settings at 224, e.g. to determine if certain tags are not to be tracked at that time due to a snooze function or other reason. The appropriate alerts are then displayed at 226. It can be appreciated that the alerts displayed at 226 may also indicate that all items are within range (i.e. a positive alert) and this may be done using a non-intrusive UI element such as the tracking status bar 200.

FIG. 19 illustrates an example set of computer executable instructions that may be implemented by the object tracking application 34 and object tracking module 30 in order to apply a snooze function, e.g. manually or through an alert as shown in FIG. 12. At 228, the object tracking application detects the selection of one of the snooze options 146, 154, 156, 162, and then determines at 230 a time at which to re-scan for the selected one or more tags 18. This can be determined through the settings or via a snooze until option (not shown) similar to calendar reminders etc. The re-scan time is then detected at 323 and a scan is performed to look for the tag 18 at 234. It can be appreciated that for efficiency purposes, the re-scan can be used to perform a re-scan for the entire area rather than only for the particular tag(s) 18. The scan as before produces a results list which can be compared to the settings at 236 and any alerts displayed at 238.

It can therefore be seen that the object tracking application 34 enables the user to selectively add or remove tags 18 while keeping them registered and enables a snooze function to be used to temporarily suppress alerts when desired. The provision of multiple simple menus with relatively few options enables the user to easily navigate between changing settings for various tags 18, registering new tags 18, initiating a scan for tags 18, removing tags 18, etc. It can be appreciated that the principles exemplified herein are equally applicable to items 16 that do not require a tag 18 e.g. wherein they comprise their own short-range communication system 20 as shown in FIG. 1.

The present invention may be utilized as process for the core application level of devices, such as the operating system of a smart phone or other device. In this embodiment of the present invention high level applications may be built upon the present invention which may represent an architectural base in this embodiment. As an example, the present invention may be utilized as a core application and may be an embedded function of the operating system. The core application may be operable to access data. The core application may be run on several platforms and devices, for example, such as tablets, laptops and other devices, as well as on cell phones, smart phones, and any other devices.

In an embodiment where the present invention represents the core application of a device, the core application may be operable to trigger a variety of activities or actions, for example, such as activities or actions that invoke one or more software applications, hardware, pairing, or other activities or actions. As an example, the core application may be operable to trigger an action when a new tag is found in proximity. In this manner the action may be triggered at a time other than when the device is leaving the reception area.

Actions and activities that the present invention may trigger may include may different types of actions and activities. As an example, the present invention may be operable to trigger an action whereby a radio map for items is provided. Said radio map may be updated as items are moved. The present invention may operate this action through elements of the software of the present invention, or may access third party software and/or hardware in order to operate this action. A skilled reader will recognize that the present invention may generally operate activities or actions that involve or otherwise integrate third party software and/or hardware.

In an embodiment of the present invention wherein the present invention comprises the core application, the present invention may be run on any device and may be operable to read one or more tags attached to one or more items. Several layers may surround the core application, for example, such as a tag level, a directional module, a third party application (App) device, a wireless network, and a third party App server. These layers may function with the core application to produce the present invention.

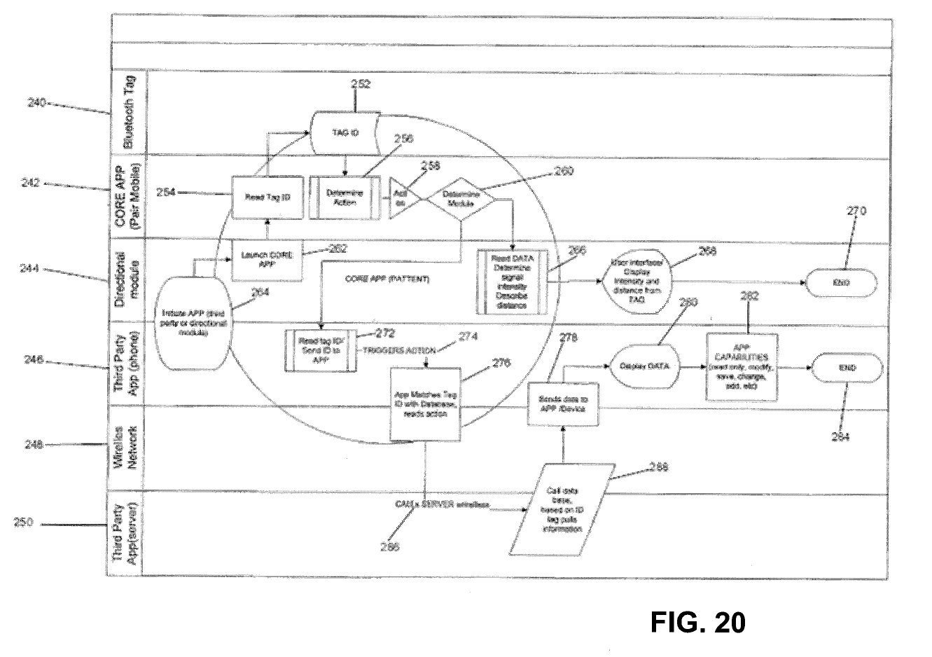

As shown in FIG. 20, core application 242 may be surrounded by the layers of a Bluetooth tag layer 240, a directional module 244, a third party App device that is a phone 246, a wireless network 248, and a third party App server 250.

A tag, such as a Bluetooth tag, may be attached to an item, and the tag may include a tag ID 252. The tag ID may be matched to an item 276, for example, such as by a matching App available via a wireless network, or another matching means that may be integrated with the present invention, or may be available via the software and/or hardware of a third party. The matching may storage of data relating to the item and the tag ID in one or more databases. The present invention may then initiate an App 264, which may be available from a third party app or a directional module.

The core application may be launched 262 following the initiation of the App 264. The core application may read a tag ID 254. The tag ID information may be provided to the core application to be utilized to determine an action 256 to be operated by the core application. The action 258 that is determined may be initiated by the core application and this action may involve a determine module 260.

The determine module 260 may undertake to access the directional module and to read data 266 therein. The accessed data may be read to determine the signal intensity and to describe the distance between the device and the item bearing the tag that has been read. A user interface 268, or other display means, may be utilized to display the intensity and distance information to a user. The process in the directional module may end 270 at this point.

The determine module 260 may also access a third party App device, such as a cell phone, or smart phone. The third party App device may be operated to read a tag ID 272 and/or to send the ID to the App. This may trigger an action 274 and the App may act to review the match information relating to the tag ID 276, for example, such as searching a database for the tag ID to determine the item relating to the tag ID. A wireless network level may be accessed to undertake reviewing the match information relating to the tag ID. A wireless server may be called 286 at the third party App server level. The call may be to a database 288, and based upon the tag ID specification information relating to the tag ID may be pulled and otherwise collected. The database may be accessed from the third party App server level, or via a wireless network level. The data relating to the tag ID that is pulled or otherwise collected may be send to the App device 278. The data may be displayed on the third party App device 280, so that a user may view the data. The App device may offer particular functions to a user 282, for example, such as read only viewing of the data, the data may be modifiable, the data may be saved, the data may be changed, data may be added, or other functions may be offered to a user. The process at the third party App device may end 284 at this point.

An embodiment of the present invention that includes a core application may involve a device including software or other computer program products whereby the device has the ability to scan and identify tags associated with items. The tags may be bluetooth, RFID, or of another type of action. Once a tag is identified, and the tag ID in particular is read, any action may be generated by the device. The actions may include any Apps accessible by the software of the device, or any other action or activity.

When the device enters into a range whereby it is in range to scan an item an action may be triggers by the present invention. An action may also be triggered by the present invention when the device leaves proximity with the item and thereby becomes out of range to scan an item. For example, when a device comes into proximity of an item, and is then in range to scan the item, the action triggered may be the action of recognizing the tag of the item, or any other action or activity may be triggered. As another example, when a device is moved out of proximity of an item, and is thereby out of range to scan the item an action may be triggered, such as a notice to the user that the device is out of range of the item, or a snooze function, or any other action or activity.

The present invention may be utilized in a variety of embodiments and in a variety of application environments. For example, in a medical environment, such as a hospital environment or long-term care facility, the present invention may be utilized to identify one or more patients. The bracelets or other tags affixed to persons, furniture, equipment or walls within a medical environment may bear a tag and be registered as tagged. Many types of information may be included in the registration of a tag, and thereby associated with the tagged person, item, wall, etc. For example, medical records may also be incorporated in the registration of particular patients, and uses may be incorporated in the registration of medical equipment. Such information may be accessible from third party servers or other storage means and thereby linked to the registration for the tag. A doctor having a device in hand, for example, such as a tablet, may be able to approach a patient and the tablet will recognize a tag of a patient at a set proximity. This recognition may trigger an action whereby the present invention may request the medical records for the tagged patient.

As another example, an embodiment of the present invention may be applied in discount sites. A user may be able to download to their smart phone or other device an App which will allow the device to recognize tags. The discount site may offer to users the option to make an in-store deal available to the App. As a user walks into a participating store, the App may recognize the tag specific to the store. This may trigger the action whereby the present invention may receive information to populate a discount offered for one or more items in the store. The information may be collected or otherwise accessed from a database. The database may be available from a linked server, a cloud, etc.

A skilled reader will recognize that other example, in other environments, may also be possible.

It will also be appreciated that the block configurations, screen shots, and flow charts provided herein are for illustrative purposes only and various modification thereof are applicable within the principles discussed herein.

Although the above principles have been described with reference to certain specific embodiments, various modifications thereof will be apparent to those skilled in the art without departing from the scope of the invention and the claims appended hereto. Other modifications are therefore possible.

We claim:

1. A method for tracking items using a device, the method comprising:
enabling an item to be registered via a short-range communication system, the item being capable of communicating via a short-range communication protocol and having associated therewith an identifier (ID);
enabling the device to scan for the item via the short-range communication protocol; and
receiving data providing the location of the item to a user.

2. The method of claim 1, comprising the further step of configuring the device to perform scanning for an item.

3. The method of claim 1, comprising the further step of upon detecting an input to the mobile device indicative of a snooze function, temporarily suppressing an alert associated with an out-of-range condition for the item.

4. The method of claim 1, comprising the further step of the short-range communication protocol transferring the item ID to the device when the device is scanning for the item.

5. The method of claim 4, comprising the further step of the pairing the item ID to item registration data to identify the item.

6. The method of claim 5, comprising the further step of looking-up the item ID in a database storing the item registration data.

7. The method of claim 1, comprising the further step of displaying data of the item scanned to a user via a display means of the device.

8. The method of claim 1, comprising the further steps of:
determining the distance between the item and the device; and
displaying the distance between the item and the device to a user via a display means.

9. The method of claim 1, comprising the further steps of:
determining the item is out of range;
capturing the position of the device relative to the item;
correlating the position of the device relative to the item to results of one or more past scans; and
generating suggestions of one or more possible locations of the item that is out of range.

10. The method of claim 9, comprising the further step of providing a possible direction that the user may move a device in order to come within range of the item.

11. A computer readable medium comprising computer executable instructions operable by a device to cause the mobile device to:
enable an item to be registered via a short-range communication system, the item being capable of communicating via a short-range communication protocol and having associated therewith an identifier (ID);
enable the device to scan for the item via the short-range communication protocol; and
receive data providing the location of the item to a user.

12. The computer readable medium of claim 11, wherein, the device is at least one of: a cell phone; a smart phone; a PDA; a digital music player; a GPS device; an e-book readers; a portable gaming device; a digital camera; a tablet; a netbook; or a laptop.

13. The computer readable medium of claim 11, wherein the item is at least one of the following: keys; a wallet; inventory items; work items; active devices; or electronic devices.

14. The computer readable medium of claim 11, wherein the short-range communication system is at least one of the following: Bluetooth; radio frequency identification; infrared; optical; or other near-field communication protocols.

15. The computer readable medium of claim 11, wherein an alert associated with an out-of-range condition for the item is temporarily suppressed upon detecting an input to the mobile device indicative of a snooze function.

16. A method for tracking items using a device, comprising:
tagging an item and registering the tagged item via a short-range communication system, the item being capable of communicating via a short-range communication protocol and having associated therewith an identifier (ID);
initiating an App on a third party device;
launching a core application enabling the device to scan for the item via the short-range communication protocol; and
determining an action and a determine module.

17. The method of claim 16, comprising the further steps of:
matching the tag ID via a wireless network to gather tag ID data;
sending the tag ID data to the third party App device; and
displaying the data to a user.

18. The method of claim 17, comprising the further step of permitting the user to read only, modify, save, change, or add data.

19. The method of claim 16, comprising the further step of utilizing a directional module to undertake the following steps:
determining a signal intensity of the device; and
determining a distance between the item and the device.

20. The method of claim 19, comprising the further step of displaying the signal intensity and the distance to a user via a display means.
